(19) United States
(12) Patent Application Publication
(10) Pub. No.: US 2024/0150185 A1
(43) Pub. Date: May 9, 2024

(54) MULTI-LAYER BOROPHENE AND METHOD OF SYNTHESIZING SAME

(71) Applicant: NORTHWESTERN UNIVERSITY, Evanston, IL (US)

(72) Inventors: Mark C. Hersam, Wilmette, IL (US); Xiaolong Liu, Ithaca, NY (US)

(21) Appl. No.: 18/281,648

(22) PCT Filed: Mar. 22, 2022
(86) PCT No.: PCT/US2022/021253

§ 371 Date: Sep. 12, 2023

Related U.S. Application Data
(60) Provisional application No. 63/167,784, filed on Mar. 30, 2021.

(51) Int. Cl. C01B 35/02

(52) U.S. Cl. CPC C01B 35/023; C01P 2002/20; C01P 2004/04; C01P 2004/20; C01P 2006/80

(57) ABSTRACT

The invention relates to multi-atomic layer borophene and a method of synthesizing multi-atomic layer borophene. The multi-atomic layer borophene comprises bilayer (BL) borophene. The BL borophene is BL-α borophene comprising two covalently bonded α-phase borophene monolayers and being metallic and in form of a highly faceted island with a six-fold symmetric Moiré superlattice surrounded by full-coverage intermixed SL v_{1/5} and v_{1/6} borophene. The BL-α borophene nucleates and emerges at intersections of multiple SL borophene domains. The synthesizing method includes depositing boron on a substrate with atomically flat terraces at a temperature in an ultrahigh vacuum (UHV) chamber to grow multi-atomic layer borophene beyond a full coverage of single-atomic layer (SL) borophene.

### CROSS-REFERENCE TO RELATED PATENT APPLICATION

This application claims priority to and the benefit of U.S. Provisional Application No. 63/167,784, filed Mar. 30, 2021, which is incorporated herein in its entirety by reference.

### STATEMENT AS TO RIGHTS UNDER FEDERALLY-SPONSORED RESEARCH

This invention was made with government support under N00014-17-1-2993 awarded by the Office of Naval Research and 1720139 awarded by the National Science Foundation. The government has certain rights in the invention.

### FIELD OF THE INVENTION

The present invention relates generally to the material science, and more particularly to multi-layer borophene and synthesis of borophene beyond the single-atomic-layer limit.

### BACKGROUND OF THE INVENTION

The background description provided herein is for the purpose of generally presenting the context of the invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the invention.

Boron is among the lightest and most chemically versatile elements in the periodic table. The diverse bonding possibilities of boron lead to at least 16 bulk polymorphs composed of interconnected icosahedrons (panel a of FIG. 1) that are not observed in other elemental materials. As further evidence of the uniqueness of boron, the most thermodynamically stable bulk polymorph, β-rhombohedral boron, is a frustrated system stabilized by a substantial concentration of intrinsic defects that display no ordering even at ultralow temperatures. This rich structural diversity also occurs in two-dimensional (2D) boron sheets, which are collectively referred to as borophene. Borophene polymorphs are characterized by triangular boron lattices with periodically arranged hollow hexagons (HHs) with a vacancy density of v (panel b of FIG. 1). Thus far, the 2D nucleation and growth of borophene has been stabilized by interfacial coupling with metal substrates including Ag, Au, Cu, Al, and Ir. The ground state lattice structure of borophene varies as a function of the growth substrate, which can be rationalized by a self-doping model where the addition of boron atoms to a honeycomb boron lattice (v=⅓) effectively releases 3 valence electrons per atom to the honeycomb skeleton. This self-doping model suggests that borophene becomes isoelectronic with graphene at v= 1/9 in vacuum and v≠ 1/9 on substrates due to additional interfacial charge transfer doping.

Given the unique combination of 2D metallicity, massless Dirac fermions, charge density waves, high mechanical strength, superconductivity, and zero interfacial tunnel barriers with semiconductors, borophene-based applications in quantum electronics, energy storage, and sensors have attracted intense interest. Although many of these applications would benefit from multi-layer borophene, all experimentally realized borophene polymorphs to date are single-atomic-layer (SL) sheets. Considering the open-shell nature and flexible bonding motifs of boron, covalently bonded multi-layer borophene is likely to be synthesizable if suitable growth conditions can be identified. This additional degree of freedom would not only expand the library of borophene structures and physical properties, but also elucidate the transition between SL borophene polymorphs and icosahedron-based bulk boron. Indeed, a large number of bilayer (BL) borophene polymorphs have been proposed. Due to anticipated interlayer bonding, many of the BL borophene polymorphs are predicted to be more stable than even the nominal ground state of SL borophene (i.e., the α-phase with v= 1/9). Extraordinary properties have also been calculated for BL borophene such as antiferromagnetism, double Dirac cones, nodal line fermions, and ultrahigh critical strains. However, BL borophene has not yet been synthesized.

Therefore, a heretofore unaddressed need exists in the art to address the aforementioned deficiencies and inadequacies.

### SUMMARY OF THE INVENTION

In one aspect, this invention relates to a method of synthesizing multi-atomic layer borophene, comprising depositing boron on a substrate with atomically flat terraces at a temperature in an ultrahigh vacuum (UHV) chamber to grow multi-atomic layer borophene beyond full coverage of single-atomic layer (SL) borophene.

In one embodiment, the temperature is at about 200-700° C. during boron deposition. In one embodiment, the temperature is around 450° C.

In one embodiment, the atomically flat terraces are micrometer-sized atomically flat terraces having widths exceeding about 1 μm.

In one embodiment, the multi-atomic layer borophene comprises bilayer (BL) borophene.

In one embodiment, the BL borophene is BL-α borophene comprising two covalently bonded α-phase borophene monolayers.

In one embodiment, the BL-α borophene is in form of a highly faceted island with a six-fold symmetric Moiré superlattice surrounded by full-coverage intermixed SL v_{1/5} and v_{1/6} borophene.

In one embodiment, the BL-α borophene nucleates and emerges at intersections of multiple SL borophene domains.

In one embodiment, the BL-α borophene has a work function exceeding hat of SL borophene.

In one embodiment, the BL-α borophene is metallic.

In one embodiment, the UHV chamber is in a vacuum level better than 10⁻⁹ Torr during the borophene growth.

In one embodiment, the substrate comprises a substrate having a metal film formed of Ag, Au, Cu, Al, or Ir.

In one embodiment, the substrate is a Ag(111) substrate.

In one embodiment, the Ag(111) substrate is obtained by repeated ion sputtering followed by thermal annealing at above 500° C., thereby forming atomically flat Ag(111) terraces with typical width exceeding about 1 μm.

In one embodiment, said depositing the boron is performed by electron-beam evaporation of a solid boron rod, or high temperature effusion of the solid boron rod in a high temperature effusion cell.

In one embodiment, the solid boron rod has a purity of about 99.999-99.99999% boron.

In one embodiment, the flux of boron during deposition is maintained at above 10 nA using a filament current above 1 A and accelerating voltage above 1 kV.

In one embodiment, the deposition time is about 1-100 min to achieve more than full monolayer coverage of boron.

In another aspect, the invention relates to the multi-atomic layer borophene synthesized according to the above-disclosed methods.

In one embodiment, the multi-atomic layer borophene comprises bilayer (BL) borophene.

In one embodiment, the BL borophene is BL-α borophene comprising two covalently bonded α-phase borophene monolayers.

In one embodiment, the BL-α borophene is in form of a highly faceted island with a six-fold symmetric Moiré superlattice surrounded by full-coverage intermixed SL v_{1/5} and v_{1/6} borophene.

In one embodiment, the BL-α borophene nucleates and emerges at intersections of multiple SL borophene domains.

In one embodiment, the BL-α borophene has a work function exceeding hat of SL borophene.

In one embodiment, the BL-α borophene is metallic.

In yet another aspect, the invention relates to a composition comprising multi-atomic layer borophene containing multiple monolayer borophenes grown one on top of another and covalently bonded to each other.

In one embodiment, the multi-atomic layer borophene comprises bilayer (BL) borophene.

In one embodiment, the BL borophene is BL-α borophene comprising two covalently bonded α-phase borophene monolayers.

In one embodiment, the BL-α borophene is in form of a highly faceted island with a six-fold symmetric Moiré superlattice surrounded by full-coverage intermixed SL v_{1/5} and v_{1/6} borophene.

In one embodiment, the BL-α borophene nucleates and emerges at intersections of multiple SL borophene domains.

In one embodiment, the BL-α borophene has a work function exceeding that of SL borophene.

In one embodiment, the composition is metallic.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows growth of bilayer (BL) graphene on Ag(111) according to embodiments of the invention. Panel a: Schematic of the B₁₂ icosahedron unit that is the basis of bulk boron polymorphs. Panel b: Schematics of single-atomic-layer (SL) v_{1/6} and v_{1/5} borophene polymorphs. Panel c: Scanning tunneling microscope (STM) topography image of an apparent BL borophene island surrounded by intermixed SL v_{1/6} and v_{1/5} borophene. STM bias voltage: Vₛ=−0.1 V.

FIG. 2 shows atomic-scale imaging of BL borophene according to embodiments of the invention. Panel a: Conventional STM topography image of BL borophene using a bare PtIr tip. The lattice vectors are indicated by the arrows. Panel b: CO-molecule-functionalized STM (CO-STM) image in the same field of view as panel a, showing improved spatial resolution. The inset is a zoomed-in image with an apparent distorted honeycomb lattice overlaid. Panel c: CO-STM image of the interface between BL borophene and v_{1/5} borophene. The schematic shows lattice alignments with the underlying Ag(111) surface. STM bias voltages: (panel a) Vₛ=−5 mV, (panel b) Vₛ=−42 mV, (panel c) Vₛ=−20 mV.

FIG. 3 shows lattice structure of BL-α borophene according to embodiments of the invention. Panel a: Top and side views of the atomic structure of BL-α borophene relaxed on Ag(111). The boron atoms forming interlayer bonds (colored red) are displaced towards the center of the BL. Panel b: Illustration of the six-fold Moiré superlattice with 2.2 nm lattice constant formed between the lattices of BL-α borophene and Ag(111). The Moiré pattern closely matches the experimental CO-STM image (inset). Panel c: Experimental CO-STM images of BL-α borophene. Panel d: Experimental CO-AFM images of BL-α borophene. Panel e: Simulated CO-STM images of BL-α borophene. Panel e: Simulated CO-AFM images of BL-α borophene. The pink hexagons in panels c-f correspond to the pink HHs in panel a. STM/AFM bias voltages: (panel c) Vₛ=−42 mV, (panel d) Vₛ=5 mV.

FIG. 4 shows spectroscopic characterization of BL-α borophene according to embodiments of the invention. Panel a: A series of differential tunneling conductance spectra taken along the line in the inset across the interface between BL-α borophene (blue) and SL v_{1/6} borophene (red). Panel b: Field-emission resonance (FER) spectra taken on BL-α borophene, SL v_{1/6} borophene, and Ag(111). Inset: Schematic illustration of the band alignment in the Fowler-Nordheim tunneling regime and the formation of Stark-shifted IPSs (orange lines). E_{vac}: vacuum level, E_{F}: Fermi level, Vₛ: sample bias voltage. Panel c: Measured lifetimes of the IPSs in Panel b. Panel d: Extracted and fitted IPS peak positions. STM bias voltage: (panel a) Vₛ=54 mV.

FIG. 5 shows large-area STM images of BL borophene growth according to embodiments of the invention. Panel a: STM image of clean Ag(111) with ˜1 μm wide atomic terraces for borophene growth. Panel b: STM image of early-stage SL borophene nucleation/growth after 20 s deposition of boron. Nucleation sites with a large density (10¹⁵/m²) are seen on Ag(111) terraces. Inset: Zoomed-in image of a small SL borophene island after nucleation around a single-atom defect at the center. Panel c: STM image of single-atomic-layer (SL) borophene at nearly full coverage. Before reaching full coverage, small islands of BL borophene start to nucleate within SL borophene domains (red arrows). It should be noted that no BL borophene domains have been observed in the middle of clean Ag(111) terraces, suggesting BL borophene nucleation only takes place on SL borophene. Panel d: Faceted BL borophene islands (red arrows) surrounded by SL borophene polymorphs at full monolayer coverage. Across all BL borophene islands, the SL borophene lattices are discontinuous, suggesting that BL borophene nucleates and emerges at intersections of multiple SL borophene domains. STM bias voltages: (panel a) Vₛ=100 mV, (panel b) Vₛ=200 mV and Vₛ=30 mV (inset), (panel c) Vₛ=10 mV, (panel d) Vₛ=100 mV.

FIG. 6 shows in situ thickness measurement of BL-α borophene according to embodiments of the invention. Panel a: STM of the boundary between BL-α borophene and SL v_{1/6} borophene. Panel b: non-contact atomic force microscopy (nc-AFM) topography images of the boundary between BL-α borophene and SL v_{1/6} borophene. The nc-AFM image is taken in constant-frequency-shift mode (Δf=−1 Hz). Panel c: Extracted height profile along the red dashed line in panel b, indicating that BL-α borophene has a thickness ˜1.4 Å larger than that of SL v_{1/6} borophene. In the constant-frequency-shift mode of nc-AFM, the tip does not physically touch the sample surface but rather traces an isosurface of constant force gradient at a height above the surface, which is dependent on the local sample properties due to tip-sample interactions. Therefore, the nc-AFM height measurement does not equal the interlayer spacing in BL-α borophene (3.1 Å). Although tip-sample interaction differences are often ignored when measuring bulk samples, in the case of thickness measurements of two-dimensional materials such as graphene, this effect can lead to thickness uncertainties above 5 Å. STM/AFM bias voltages: (panel a) Vₛ=100 mV, (panel b) Vₛ=200 mV.

FIG. 7 shows instability of SL v_{1/9} borophene on Ag(111) according to embodiments of the invention. SL v_{1/9} borophene possesses a triangular lattice of hollow hexagons (pink hexagons). However, upon relaxation on Ag(111) with initial lattice constants and lattice alignment determined from panel a of FIG. 3 and panel c of FIG. 2, respectively, SL v_{1/9} borophene is unstable and becomes disordered.

FIG. 8 shows average bond lengths in BL-α borophene according to embodiments of the invention. The bonds indicated by the blue and black arrows are inequivalent and have average lengths of 1.8507 Å and 1.8245 Å, respectively.

FIG. 9 shows electronic structure of BL-α borophene according to embodiments of the invention. Panel a: The first Brillouin zone of BL-α borophene with high-symmetry points labeled. Panel b: Calculated band structure of BL-α borophene. The presence of multiple bands crossing the Fermi level suggests that BL-α borophene is metallic. The presence of a Dirac cone at the K-point and ˜10 meV below the Fermi level is indicated by a red circle. Panel c: Three-dimensional view of the Dirac cone at the K-point. The units for kₓ and k_{y} are Å⁻¹. For the band structure calculations, the BL-α borophene lattice is isolated from Ag(111). The angularly averaged Fermi velocity of the Dirac cone in panel c is ˜2.3×10⁵ m/s.

FIG. 10 shows FER spectra on BL-α borophene at different setup conditions according to embodiments of the invention. According to equation (1), Vₙ∝E^{2/3}, and thus image-potential states are expected to shift to higher energies with larger electric field or higher setup current (indicated by blue dashed lines), while other electronic states are not expected to show obvious dependence on the electric field (indicated by grey dashed lines).

FIG. 11 shows interfacial charge transfer doping of BL-α borophene on Ag(111) according to embodiments of the invention. Cross-sectional view of the isosurfaces of charge redistribution indicating electron transfer doping of BL-α borophene from Ag(111) with a density of 0.006 electron/Å².

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this specification will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that, as used in the description herein and throughout the claims that follow, the meaning of “a”, “an”, and “the” includes plural reference unless the context clearly dictates otherwise. Also, it will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures. is turned over, elements described as being on the “lower” side of other elements would then be oriented on “upper” sides of the other elements. The exemplary term “lower”, can, therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” or “has” and/or “having”, or “carry” and/or “carrying,” or “contain” and/or “containing,” or “involve” and/or “involving, and the like are to be open-ended, i.e., to mean including but not limited to. When used in this specification, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification, and will not be interpreted in an idealized or overly formal sense unless expressly so defined herein.

As used in this specification, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in this specification, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in a different order (or concurrently) without altering the principles of the invention.

Borophene refers to the family of synthetic two-dimensional polymorphs of boron, which has attracted significant attention due to anisotropic metallicity, correlated electron phenomena, and diverse superlattice structures. However, to date, all experimentally realized borophene polymorphs are atomically thin planar structures with similar electronic properties. Although multi-atomic layer borophene polymorphs with superior electronic and mechanical properties have been theoretically proposed, none of them has been experimentally synthesized. Towards this end, this invention achieves the first experimental synthesis of bilayer (BL) borophene by depositing elemental boron beyond monolayer coverage on Ag(111) surfaces with micrometer-sized atomically flat terraces. The atomic structure is determined to be two covalently bonded α-phase borophene monolayers. Compared to monolayer borophene polymorphs, BL borophene has a much higher work function exceeding about 5 eV. Overall, this invention reveals the possibility of synthesizing borophene beyond the single-atomic-layer limit, which is likely to inspire and motivate further exploration of multi-layer borophene synthesis.

In one aspect of the invention, the method of synthesizing multi-atomic layer borophene comprises depositing boron on a substrate with atomically flat terraces at a temperature in an ultrahigh vacuum (UHV) chamber to grow multi-atomic layer borophene beyond full coverage of SL borophene.

In certain embodiments, the temperature is at about 200-700° C. during boron deposition. In certain embodiments, the temperature is around 450° C.

In certain embodiments, the atomically flat terraces are micrometer-sized atomically flat terraces having widths exceeding about 1 μm.

In certain embodiments, the multi-atomic layer borophene comprises bilayer (BL) borophene.

In certain embodiments, the BL borophene is BL-α borophene comprising two covalently bonded α-phase borophene monolayers.

In certain embodiments, the BL-α borophene is in form of a highly faceted island with a six-fold symmetric Moiré superlattice surrounded by full-coverage intermixed SL v_{1/5} and v_{1/6} borophene.

In certain embodiments, the BL-α borophene nucleates and emerges at intersections of multiple SL borophene domains.

In certain embodiments, the BL-α borophene has a work function exceeding about 5 eV.

In certain embodiments, the BL-α borophene is metallic.

In certain embodiments, the UHV chamber is in a vacuum level better than 10⁻⁹ Torr during the borophene growth.

In certain embodiments, the substrate comprises a substrate having a metal film formed of Ag, Au, Cu, Al, or Ir.

In certain embodiments, the substrate is a Ag(111) substrate.

In certain embodiments, the single-crystal Ag(111) substrate is obtained by repeated ion sputtering followed by thermal annealing at above 500° C., thereby forming atomically flat Ag(111) terraces with typical width exceeding about 1 μm.

In certain embodiments, said depositing the boron is performed by electron-beam evaporation of a solid boron rod, or high temperature effusion of the solid boron rod in a high temperature effusion cell.

In certain embodiments, the solid boron rod has a purity of about 99.999-99.99999% boron.

In certain embodiments, the flux of boron during deposition is maintained at above 10 nA using a filament current above 1 A and accelerating voltage above 1 kV.

In certain embodiments, the deposition time is about 10-100 min to achieve more than full monolayer coverage of boron.

In another aspect, the invention relates to the multi-atomic layer borophene synthesized according to the above-disclosed methods.

In certain embodiments, the multi-atomic layer borophene comprises bilayer (BL) borophene.

In certain embodiments, the BL borophene is BL-α borophene comprising two covalently bonded α-phase borophene monolayers.

In certain embodiments, the BL-α borophene is in form of a highly faceted island with a six-fold symmetric Moiré superlattice surrounded by full-coverage intermixed SL v_{1/5} and v_{1/6} borophene.

In certain embodiments, the BL-α borophene nucleates and emerges at intersections of multiple SL borophene domains.

In certain embodiments, the BL-α borophene has a work function exceeding about 5 eV.

In certain embodiments, the BL-α borophene is metallic.

In yet another aspect, the invention relates to a composition comprising multi-atomic layer borophene containing multiple monolayer borophenes grown one on top of another and covalently bonded to each other.

In certain embodiments, the multi-atomic layer borophene comprises bilayer (BL) borophene.

In certain embodiments, the BL borophene is BL-α borophene comprising two covalently bonded α-phase borophene monolayers.

In certain embodiments, the BL-α borophene is in form of a highly faceted island with a six-fold symmetric Moiré superlattice surrounded by full-coverage intermixed SL v_{1/5} and v_{1/6} borophene.

In certain embodiments, the BL-α borophene nucleates and emerges at intersections of multiple SL borophene domains.

In certain embodiments, the BL-α borophene has a work function exceeding that of SL borophene.

In certain embodiments, the composition is metallic.

Briefly, this invention discloses, among other things, the synthesis method of an atomically well-defined borophene polymorph beyond the single-atomic-layer (SL) limit. The structure of this bilayer (BL) borophene is consistent with two covalently bonded α-phase layers (termed BL-α borophene) as evidenced from bond-resolved scanning tunneling microscopy, non-contact atomic force microscopy, and density functional theory calculations. While the electronic density of states near the Fermi level of BL-α borophene is similar to SL borophene polymorphs, field-emission resonance spectroscopy reveals distinct interfacial charge transfer doping and a heightened local work function exceeding 5 eV. The extension of borophene polymorphs beyond the SL limit significantly expands the phase space for boron-based nanomaterials.

Among other things, the invention provides a number of advantages. Bilayer borophene is a new synthetic 2D material. Unlike monolayer borophene polymorphs, bilayer borophene has a large work function exceeding 5 eV, making it more appealing in certain electronic device applications. In addition, unlike monolayer borophene polymorphs, the bilayer borophene lattice has higher symmetry and therefore more isotropic in-plane properties, making it favorable for electronic and optoelectronic applications. The realization of bilayer borophene with a drastically increased work function and isotropic properties make it more suitable and tunable for applications in, but not limited to, electronics, optoelectronics, high frequency logic, sensing, medical imaging, energy harvesting, energy storage, quantum information, and related technologies.

These and other aspects of the invention are further described below. Without intent to limit the scope of the invention, exemplary instruments, apparatus, methods, and their related results according to the embodiments of the invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### EXAMPLE

### Borophene Synthesis Beyond the Single-Atomic-Layer Limit

In this exemplary study, the synthesis of bilayer (BL) borophene is demonstrated on Ag(111) via molecular beam epitaxy in ultrahigh vacuum. Bond-resolved imaging of the resulting BL borophene is achieved with in situ scanning tunneling microscopy (STM) and non-contact atomic force microscopy (nc-AFM) using chemically functionalized probes. Comparison of these atomic-scale spatial resolution images with density functional theory (DFT) calculations allows the structure to be identified as two sparsely covalently bonded α-phase layers (termed BL-α borophene). Furthermore, through field-emission resonance (FER) spectroscopy, a series of Stark-shifted image potential states (IP S s) are resolved for BL-α borophene, which reveal superior crystallinity and a heightened work function compared to SL borophene polymorphs. Overall, this work establishes growth conditions for borophene beyond the SL limit, which enables future studies of the physics, chemistry, and applications of multi-layer borophene.

### Methods

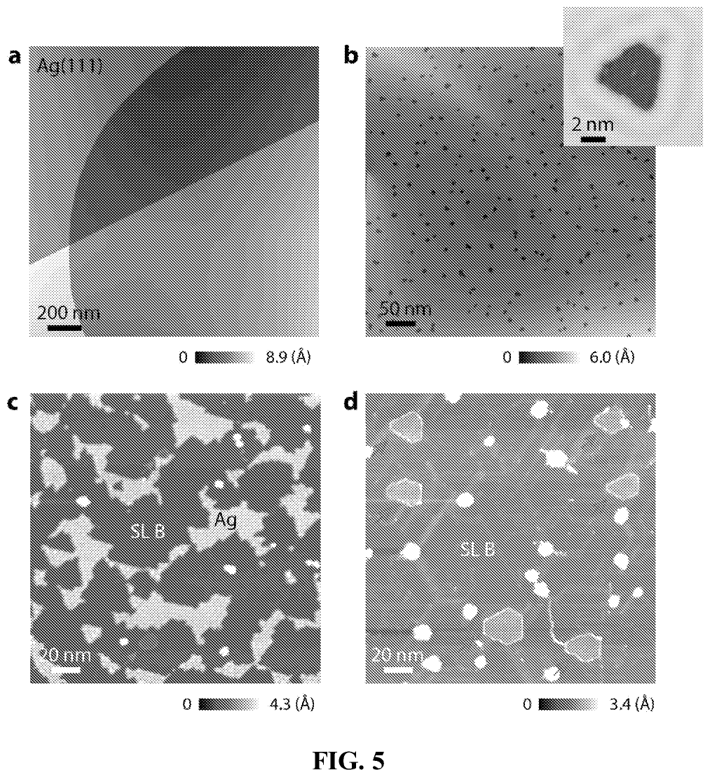

Growth of borophene polymorphs: The growth of SL and BL borophene polymorphs is performed using electron-beam evaporation (FOCUS EFM 3) of a pure boron rod (ESPI metals, 99.9999% purity) onto single-crystal Ag(111) substrates (Princeton Scientific Corp.) held at 350-450° C. in an ultrahigh vacuum preparation chamber (2×10⁻¹⁰ Torr). The Ag(111) crystals are prepared by repeated 30 min Ar ion sputtering with 1 keV energy at 1.5×10⁻⁵ Torr followed by 30 min annealing at 650° C. Annealing at such high temperature (as opposed to <550° C. for SL borophene growth) guarantees the formation of flat Ag(111) terraces with typical width exceeding 1 μm, as shown in FIG. 5. As a result, the majority of the borophene nucleation sites are on terraces (FIG. 5) instead of along step edges, which have a stronger templating effects in aligning domains than terraces. This scenario favors the formation of SL borophene grain boundaries where BL-α borophene nucleates and grows. The large Ag(111) terraces also minimize the nucleation of 3D boron particles at Ag step edges caused by the Ehrlich-Schwoebel barrier when the borophene coverage approaches monolayer. It is also found that BL-α borophene growth is favored at relatively low temperatures below 450° C., where only mixed-phase (v_{1/5} and v_{1/6} borophene) and pure v_{1/6} borophene grows. Consequently, BL-α borophene has not been observed to form with pure v_{1/5} or rotationally incommensurate borophene phases grown at higher temperatures. The flux of boron during deposition is maintained at 10-20 nA using a filament current of ˜1.5 A and accelerating voltage of ˜1.7 kV. The deposition time is 30-45 min to achieve more than full monolayer coverage of boron.

Scanning probe microscopy and spectroscopy: Low-temperature (˜4 K) STM, nc-AFM, and spectroscopy measurements are performed with a Scienta Omicron LT STM (2×10⁻¹¹ mbar) interfaced with SPECS Nanonis control electronics using electrochemically etched PtIr STM tips (Keysight) and tungsten qPlus AFM sensors (Scienta Omicron). Functionalization of the tip with CO is achieved by picking up individual CO molecules adsorbed on the sample surface by ramping the sample bias down to −2 mV and the tunneling current up to 1 nA. In nc-AFM measurements, a tip oscillation amplitude of 1-2 Å is used. CO-STM and CO-AFM measurements are performed in the constant-height mode. A lock-in amplifier (SRS model SR850) is used for spectroscopy measurements with 2 mV_{RMS} modulation amplitude and ˜800 Hz modulation frequency. In FER spectroscopy, the feedback loop is maintained while the sample bias is ramped up to 10 V so that tunneling current does not get saturated. Gwyddion software is used for image processing.

Density functional theory calculations: The calculations are performed with the Perdew-Burke-Ernzerhof (PBE) and generalized gradient approximation (GGA) in the framework of the projector augmented wave (PAW) method, as implemented in the Vienna Ab-initio Simulation Package (VASP). DFT-D2 method of Grimme is used to simulate the van der Waals interactions. A plane-wave kinetic energy cutoff of 500 eV is used. A vacuum slab of 15 Å is used to minimize the interactions between periodic cells. The bilayer borophene sheet is placed on 3 layers of Ag with the bottom layer fixed. The whole system is relaxed until the force on each atom is below 0.01 eV/Å. 2×2×1 k-points are used, with dipole corrections perpendicular to the surface. The CO-STM and CO-AFM image simulations are performed with the Probe Particle STM (PPSTM) and ProbeParticleModel packages.

### Results and Discussion

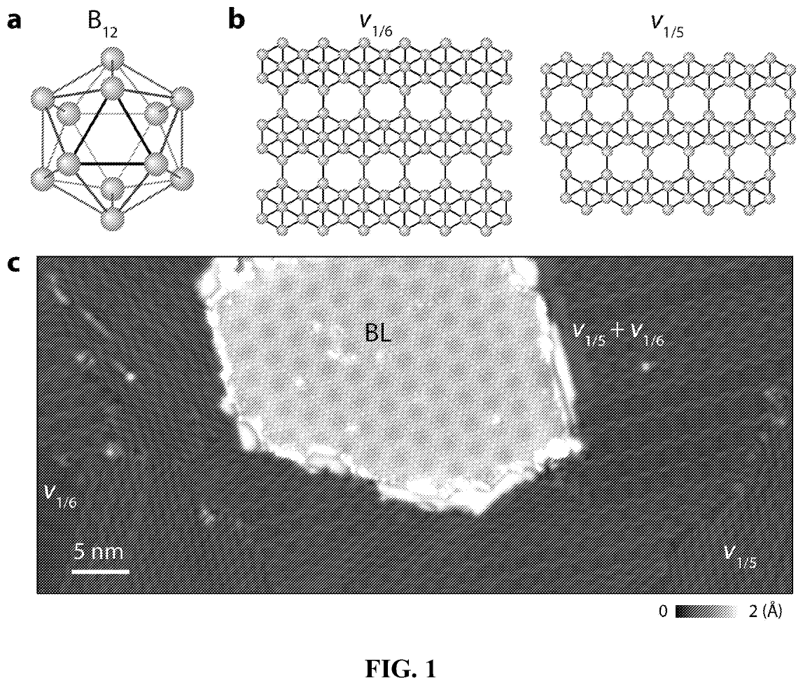

Unlike the self-terminating monolayer growth of van der Waals 2D materials on catalytic metal substrates, the possibility of interlayer bonding between two borophene atomic layers hints at a potential synthetic pathway to BL borophene. Since 2D nucleation is favorable for boron atoms in the presence of bare Ag(111) surfaces, BL borophene is hypothesized to nucleate after full coverage of SL borophene. Taking this approach, elemental boron was deposited beyond monolayer coverage onto single-crystal Ag(111) surfaces held at 350-450° C. (FIG. 5). As detailed in Methods above, the key to the growth of bilayer borophene is large, atomically flat Ag(111) terraces exceeding 1 μm widths that promote random nucleation of SL borophene. Following this procedure, STM topographic imaging, as shown in panel c of FIG. 1, reveals a highly faceted island with a six-fold symmetric Moiré superlattice surrounded by full-coverage intermixed SL v_{1/5} and v_{1/6} borophene. As discussed below in detail, this island is BL borophene with a structure consistent with two covalently bonded α-phase borophene atomic layers (i.e., BL-α borophene). The discontinuity and misorientation of the SL borophene lattices across the BL borophene island suggests that BL borophene nucleates and emerges at intersections of multiple SL borophene domains.

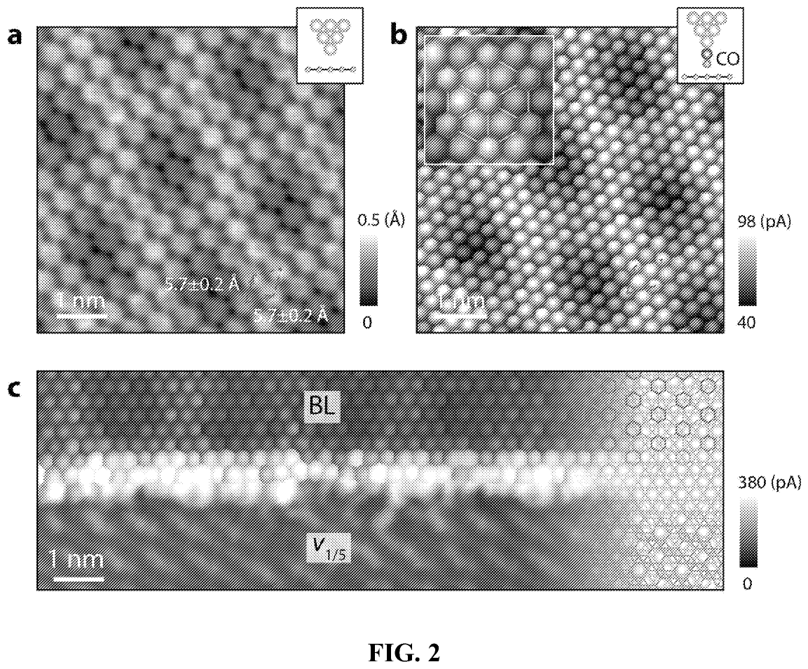

With a bare PtIr STM tip, the unit cell of the BL borophene island is resolved in panel a of FIG. 2. Because the 5.7±0.2 Å lattice constant is too large for a single B—B bond, improved spatial resolution was sought by employing CO-molecule-functionalized STM (CO-STM) imaging in constant height mode, which has been previously used to resolve complex bonding configurations of SL borophene polymorphs. In the same field of view, the CO-STM image in panel b of FIG. 2 shows a finer honeycomb-like lattice. Close inspection reveals two types of inequivalent hexagons (pink and grey, panel b of FIG. 2 inset) tiled into a Kekulé-distorted honeycomb pattern. Since CO-STM is not sensitive to three-membered boron rings, the schematic illustrates an apparent lattice with potentially hidden structural details as discussed below.

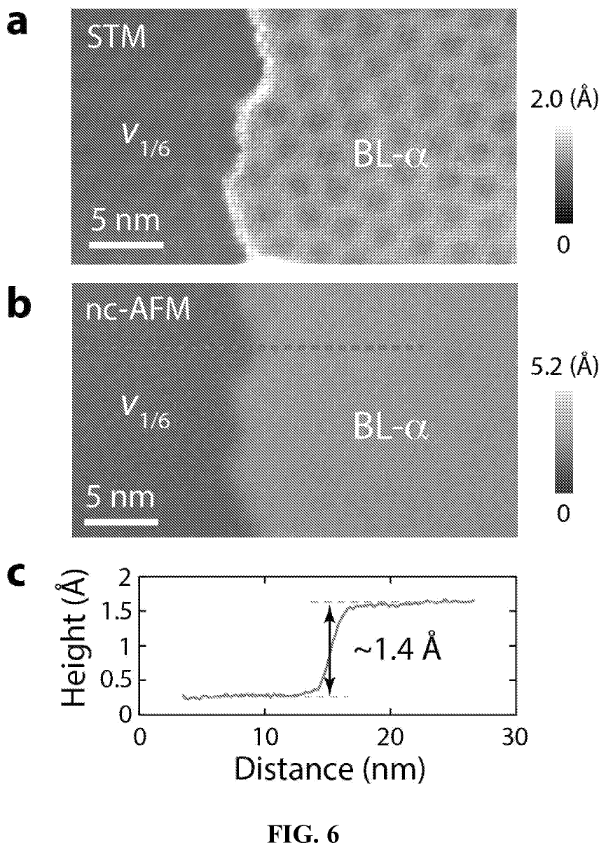

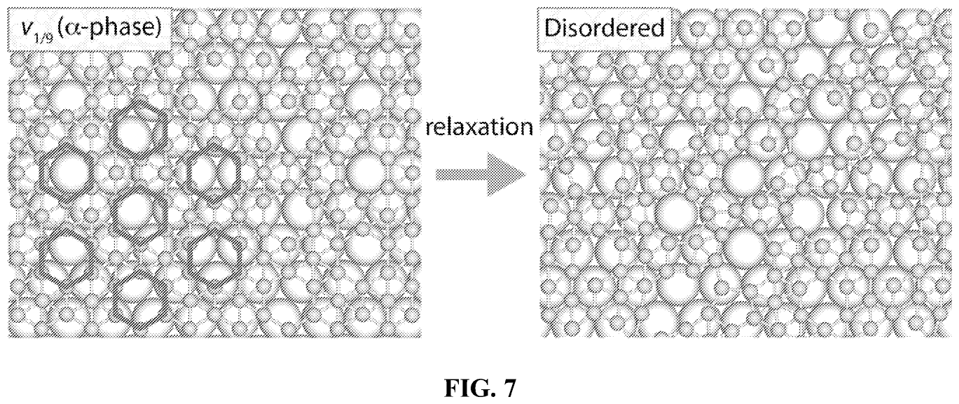

When attempting to identify the atomic structure of the apparent BL borophene polymorph, it is worth noting that the six-fold symmetry and inequivalent hexagons resemble the lattice of SL α-phase borophene. Another hint comes from the alignment of the BL borophene island with the underlying Ag(111) lattice. In particular, panel c of FIG. 2 shows a CO-STM image of the interface between SL v_{1/5} borophene and the BL borophene island. Albeit incommensurate, the interface of the two lattices is straight and abrupt. Given the known orientation of SL v_{1/5} borophene with Ag(111), the zigzag direction of the BL borophene island can be deduced to be along the Ag(111) atomic rows, as shown in panel c of FIG. 2. The possibility of SL α-phase borophene is ruled out because the thickness of the BL borophene island is larger than that of SL borophene (FIG. 6) in addition to DFT calculations showing that SL α-phase borophene is unstable on Ag(111) (FIG. 7).

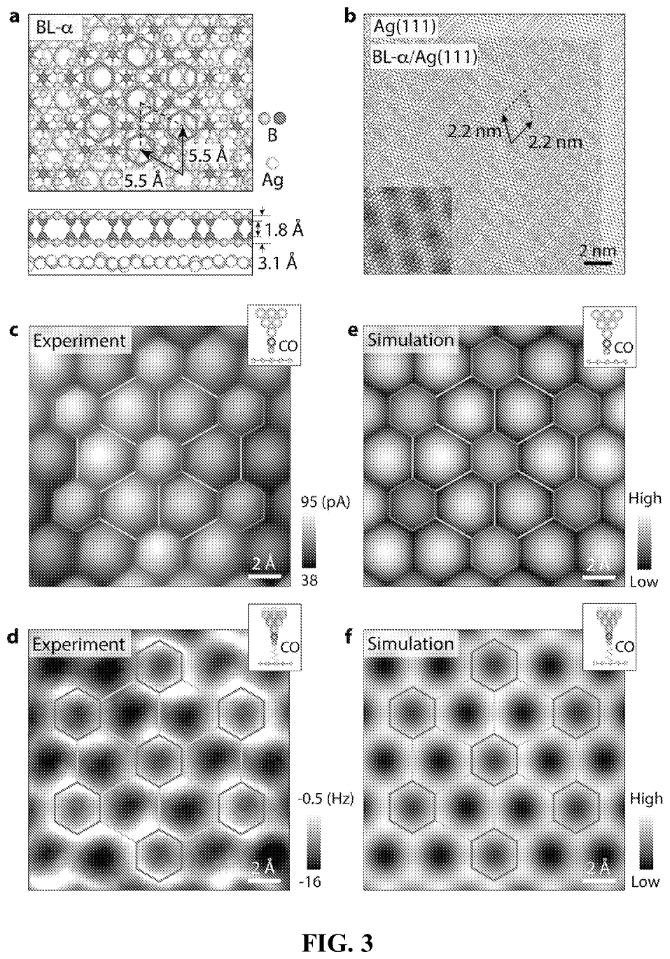

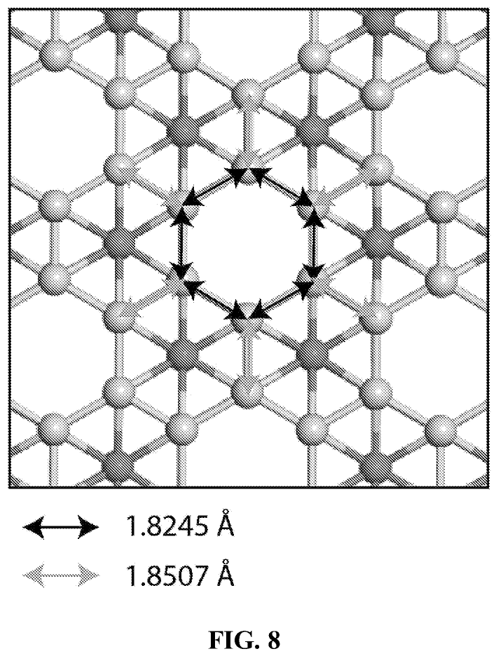

However, stacked bilayer α-phase borophene (BL-α borophene, panel a of FIG. 3) is determined to be consistent with the experimental observations of BL borophene. The first piece of evidence comes from DFT calculations, which yield a lattice constant of 5.5 Å when BL-α borophene is relaxed on Ag(111), in close agreement with STM measurements. Secondly, by overlapping the BL-α borophene lattice onto Ag(111) with the orientation determined from panel c of FIG. 2, the six-fold symmetric Moiré superlattice with ˜2.2 nm periodicity is reproduced as shown in panel b of FIG. 3. Finally, we compare experimental bond-resolved images of BL borophene using CO-STM (panel c of FIG. 3) and CO-AFM (panel d of FIG. 3) with simulated images (panels e-f of FIG. 3 respectively) based on the BL-α borophene structure. Despite two completely different imaging mechanisms, both simulated images closely match the experimental data, providing strong corroborating evidence for the BL-α borophene structure. Although the HHs (pink hexagons) in the lattice structure are evident in all of the experimental and simulated images, the triangular lattice composed of three-membered boron rings show virtually no contrast, giving rise to the appearance of a distorted honeycomb lattice. The inability of CO-functionalized tips to resolve three-membered boron rings is also the case for SL borophene. The downward buckling of the B atoms in the top layer forming interlayer bonds (red atoms in panel a of FIG. 3) further suppresses contrast formation. Although both experimental and simulated images suggest two significantly different B—B bond lengths responsible for the apparent Kekulé-distorted honeycomb lattice, the actual bond lengths only marginally differ by 1.4%, as shown in FIG. 8. The apparent bond length difference is a known imaging artifact due to dynamic deflection of flexible probe adsorbates such as CO molecules.

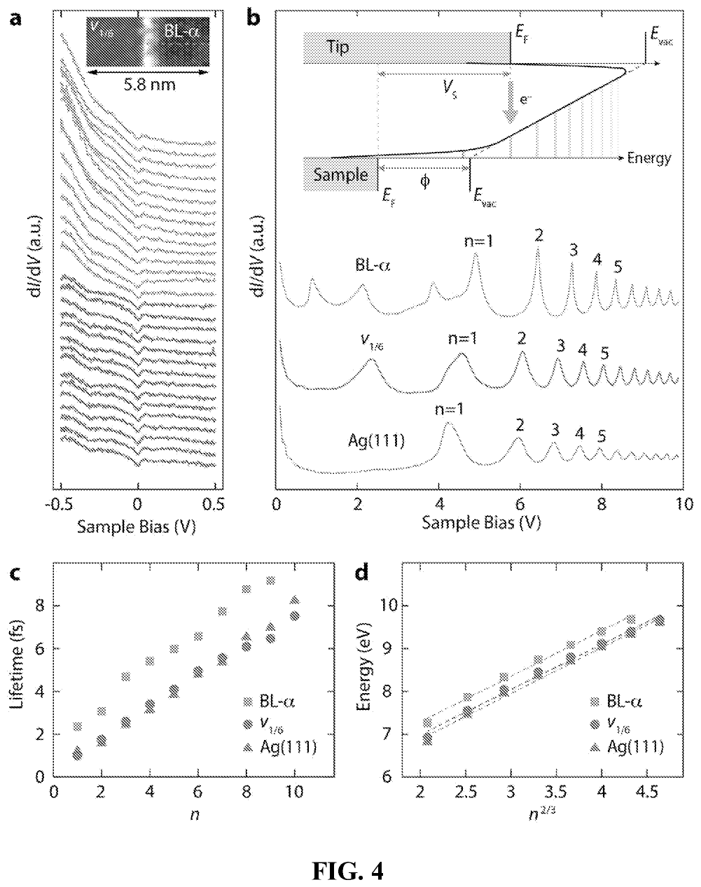

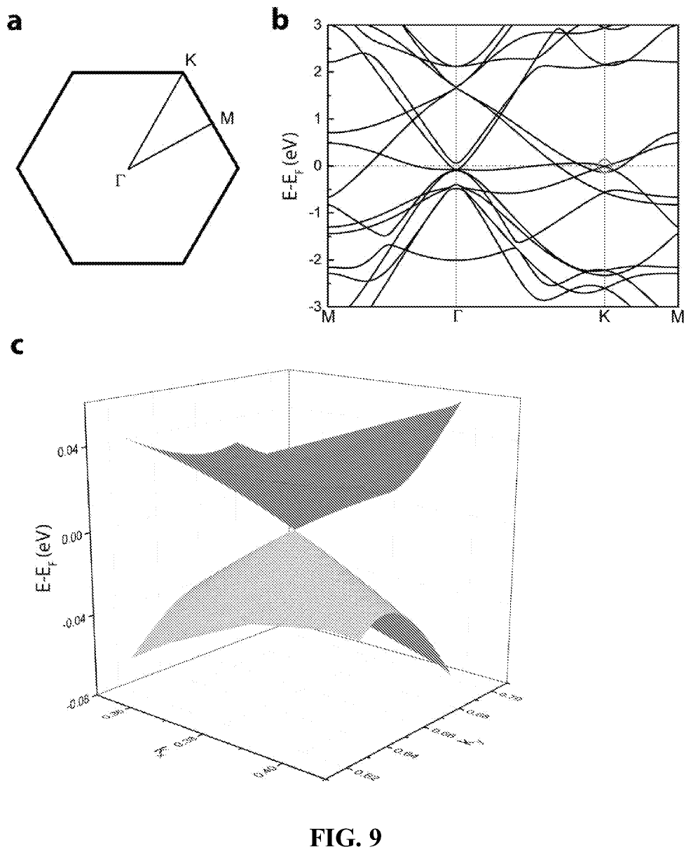

One of the defining characteristics of SL borophene polymorphs compared to insulating bulk boron is their metallicity. Instead of the interconnected icosahedrons of bulk boron, BL-α borophene retains the structural motif of SL borophene and thus electronically resembles SL borophene as a 2D metal in the vicinity of the Fermi level, as predicted by DFT calculations, as shown in FIG. 9. Experimentally, the metallicity of BL-α borophene is evident from a series of differential tunneling conductance curves taken across the boundary between v_{1/6} and BL-α borophene, as shown in panel a of FIG. 4. Although a slightly higher local density of states is observed at negative sample bias on BL-α borophene, the overall spectral shape follows that of SL v_{1/6} borophene. Similar to graphene, Dirac cones are calculated for BL-α borophene at the K-points in reciprocal space and ˜10 meV below the Fermi level, as shown in FIG. 9. Since these subtle features in the band structure are not observable with scanning tunneling spectroscopy, they are recommended for exploration in future angle-resolved photoemission studies.

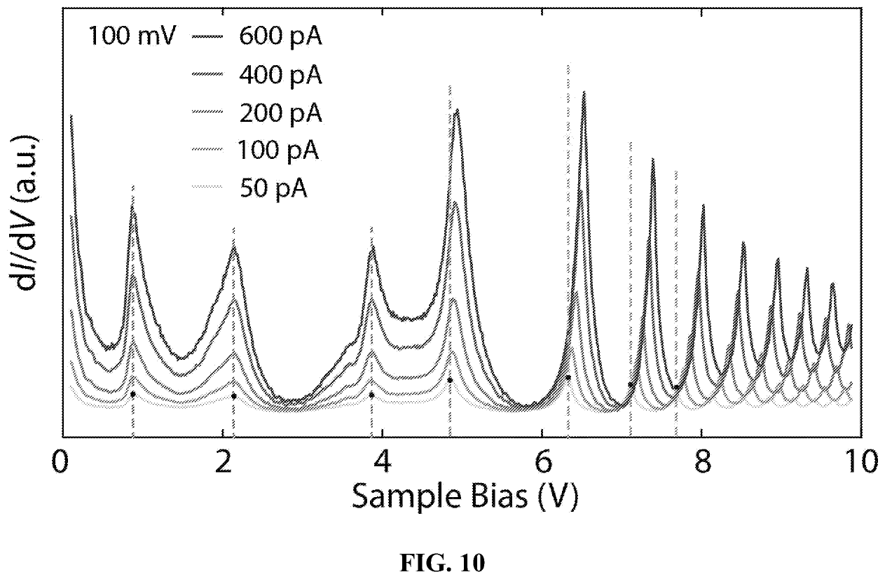

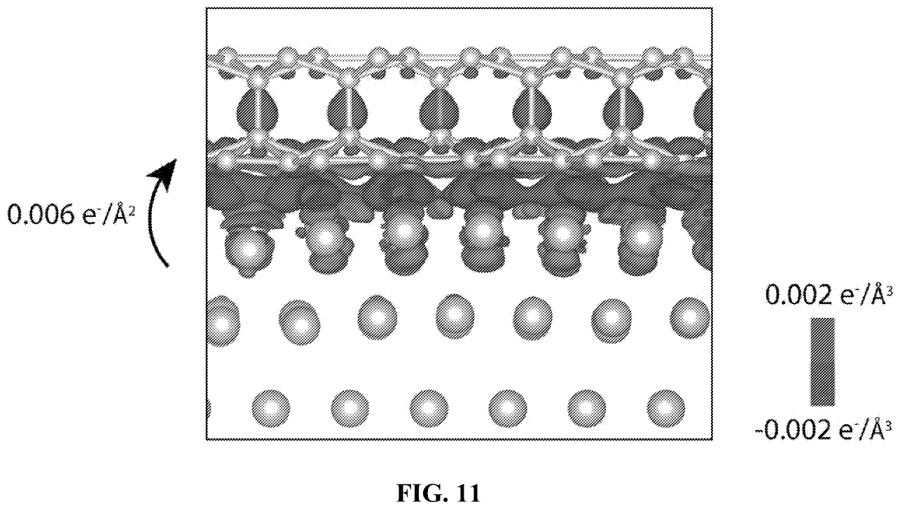

By applying bias voltages over the local work function (LWF) of the sample, electrons tunnel from the tip in the Fowler-Nordheim regime, giving access to high-lying Stark-shifted IPSs (panel b of FIG. 4 inset, orange lines) at the following energies:

$$e {V}_{n} = ϕ + {( \frac{3 n π ℏ eE}{2 \sqrt{2 m}} )}^{2 / 3} \qquad ( 1 )$$

where Vₙ is the sample voltage for the n^{th} IPS, ϕ is the LWF of the sample, m is the free electron mass, and E is the electric field. Panel b of FIG. 4 shows the series of IPSs in the FER spectra measured on BL-α borophene, SL v_{1/6} borophene, and Ag(111). The discrimination of IPSs from other electronic states is facilitated by systematic shifts of the IPSs with electric field, as shown in FIG. 10. The IPSs of BL-α borophene are significantly sharper than those on v_{1/6} borophene and Ag(111), which are quantified by scattering-induced finite lifetimes (τₙ) as calculated from the full-width-at-half-maximum (Γₙ) of the n^{th} IPS peak: τₙ=ℏ/Γₙ. As shown in panel c of FIG. 4, τₙ increases with n, consistent with decreased wavefunction overlap between IPSs and bulk states for larger n. The significantly greater lifetimes observed on BL-α borophene are consistent with superior crystallinity and the greater spatial separation of the IPSs from the underlying Ag(111) substrate. By plotting Vₙ with respect to n^{2/3} in panel d of FIG. 4, the data points lie on straight lines, allowing direct extraction of LWFs: ϕ_{BL-α}=5.15±0.15 eV, ϕᵥ_{_{1/6}}=4.88±0.14 eV, and ϕ_{Ag}=4.74±0.14 eV. The higher LWF for BL-α borophene compared to Ag(111) suggests electron transfer doping from the substrate, which forms inward electric dipoles at the interface between B and Ag consistent with DFT calculations (FIG. 11). From the simple self-doping picture, α-phase borophene with v= 1/9 achieves charge balance and thus minimal interfacial charge transfer is expected when in contact with a metal substrate. However, the formation of interlayer covalent bonds in BL-α borophene consumes electrons that are otherwise available for self-doping, which implies that electron transfer from the substrate is still expected in BL-α borophene.

In general, a BL borophene polymorph composed of two identical SL borophene layers is characterized by two parameters: hollow hexagon (HH) density v=n/N, where n and N are the number of HHs and B atoms in an otherwise SL triangular lattice, respectively, and interlayer bonding density u=m/N, where m is the number of B atoms forming interlayer bonds in each SL. If each interlayer bond consumes 77 electrons, each of the bond-forming B atoms loses η/2 electrons for self-doping. Because the consumption of every 3 electrons effectively increases the number of HHs by one, the total consumption of mη/2 electrons per atomic layer due to interlayer bond formation increases the HH density effectively to v_{eff}=v+uη/6. Assuming two-electron interlayer bonds for BL-α borophene, one has v= 1/9, u= 2/9, and η=2, which implies v_{eff}= 1/5.4. Although idealized, this analysis suggests that BL-α borophene has an electron count similar to v_{1/5} and v_{1/6} borophene, which are the two most stable and experimentally realized SL borophene polymorphs on Ag(111), again supporting the formation of BL-α borophene.

In summary, by controlled boron deposition beyond the monolayer level on atomically flat single-crystal Ag(111), BL borophene has been synthesized. By comparing bond-resolved experimental images with DFT calculations, the atomic structure of the observed BL borophene is consistent with two covalently bonded α-phase borophene atomic layers. BL-α borophene is observed to preserve the metallicity of SL borophene but with higher crystallinity and LWF as determined by FER spectroscopy. Given the intense interest in tailoring the physical characteristics of synthetic 2D boron such as LWF and the previous absence of boron polymorphs in the intermediate regime between SL borophene and bulk icosahedral boron, this work will inform future efforts aimed at understanding and exploiting multi-layer borophene.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

Some references, which may include patents, patent applications, and various publications, are cited and discussed in the description of this invention. The citation and/or discussion of such references is provided merely to clarify the description of the invention and is not an admission that any such reference is “prior art” to the invention described herein. All references cited and discussed in this specification are incorporated herein by reference in their entireties and to the same extent as if each reference was individually incorporated by reference.

### LIST OF REFERENCES

[1]. Zhai, H.-J., Kiran, B., Li, J. & Wang, L.-S. Hydrocarbon analogues of boron clusters—planarity, aromaticity and antiaromaticity. Nat. Mater. 2, 827-833 (2003).
[2]. Zhai, H.-J., Alexandrova, A. N., Birch, K. A., Boldyrev, A. I. & Wang, L.-S. Hepta- and octacoordinate boron in molecular wheels of eight- and nine-atom boron clusters: Observation and confirmation. Angew. Chem. Int. Ed. 42, 6004-6008 (2003).
[3]. Ogitsu, T., Schwegler, E. & Galli, G. β-rhombohedral boron: At the crossroads of the chemistry of boron and the physics of frustration. Chem. Rev. 113, 3425-3449 (2013).
[4]. Ogitsu, T. et al. Imperfect crystal and unusual semiconductor: Boron, a frustrated element. J. Am. Chem. Soc. 131, 1903-1909 (2009).
[5]. Mannix, A. J., Zhang, Z., Guisinger, N. P., Yakobson, B. I. & Hersam, M. C. Borophene as a prototype for synthetic 2D materials development. Nat. Nanotechnol. 13, 444-450 (2018).
[6]. Mannix, A. J. et al. Synthesis of borophenes: Anisotropic, two-dimensional boron polymorphs. Science 350, 1513-1516 (2015).
[7]. Feng, B. et al. Experimental realization of two-dimensional boron sheets. Nat. Chem. 8, 563-568 (2016).
[8]. Liu, X., Zhang, Z., Wang, L., Yakobson, B. I. & Hersam, M. C. Intermixing and periodic self-assembly of borophene line defects.Nat. Mater. 17, 783-788 (2018).
[9]. Liu, X. et al. Self-assembly of electronically abrupt borophene/organic lateral heterostructures. Sci. Adv. 3, e1602356 (2017).
[10]. Liu, X. & Hersam, M. C. Borophene-graphene heterostructures. Sci. Adv. 5, eaax6444 (2019).
[11]. Feng, B. et al. Dirac fermions in borophene. Phys. Rev. Lett. 118, 096401 (2017).
[12]. Kiraly, B. et al. Borophene synthesis on Au(111). ACS Nano 13, 3816-3822 (2019).
[13]. Wu, R. et al. Large-area single-crystal sheets of borophene on Cu(111) surfaces. Nat. Nanotechnol. 14, 44-49 (2019).
[14]. Li, W. et al. Experimental realization of honeycomb borophene. Sci. Bull. 63, 282-286 (2018).
[15]. Vinogradov, N. A., Lyalin, A., Taketsugu, T., Vinogradov, A. S. & Preobrajenski, A. Single-phase borophene on Ir(111): formation, structure, and decoupling from the support. ACS Nano 13, 14511-14518 (2019).
[16]. Tang, H. & Ismail-Beigi, S. Self-doping in boron sheets from first principles: A route to structural design of metal boride nanostructures. Phys. Rev. B 80, 134113 (2009).
[17]. Zhang, Z., Yang, Y., Penev, E. S. & Yakobson, B. I. Elasticity, flexibility, and ideal strength of borophenes. Adv. Funct. Mater. 27, 1605059 (2017).
[18]. Penev, E. S., Kutana, A. & Yakobson, B. I. Can two-dimensional boron superconduct? Nano Lett. 16, 2522-2526 (2016).
[19]. Yang, J. et al. Interfacial properties of borophene contacts with two-dimensional semiconductors. Phys. Chem. Chem. Phys. 19, 23982-23989 (2017).
[20]. Huang, Y., Shirodkar, S. N. & Yakobson, B. I. Two-dimensional boron polymorphs for visible range plasmonics: A first-principles exploration. J. Am. Chem. Soc. 139, 17181-17185 (2017).
[21]. Zhang, X. et al. Borophene as an extremely high capacity electrode material for Li-ion and Na-ion batteries. Nanoscale 8, 15340-15347 (2016).
[22]. Shukla, V., Wärnå, J., Jena, N. K., Grigoriev, A. & Ahuja, R. Toward the realization of 2D borophene based gas sensor. J. Phys. Chem. C 121, 26869-26876 (2017).
[23]. Gao, N., Wu, X., Jiang, X., Bai, Y. & Zhao, J. Structure and stability of bilayer borophene: The roles of hexagonal holes and interlayer bonding. FlatChem 7, 48-54 (2018).
[24]. Ma, F. et al. Graphene-like two-dimensional ionic boron with double Dirac cones at ambient condition. Nano Lett. 16, 3022-3028 (2016).
[25]. Zhou, X.-F. et al. Two-dimensional magnetic boron. Phys. Rev. B 93, 085406 (2016).
[26]. Xu, S.-G., Zheng, B., Xu, H. & Yang, X.-B. Ideal nodal line semimetal in a two-dimensional boron bilayer. J. Phys. Chem. C 123, 4977-4983 (2019).
[27]. Zhong, H., Huang, K., Yu, G. & Yuan, S. Electronic and mechanical properties of few-layer borophene. Phys. Rev. B 98, 054104 (2018).
[28]. Liu, X. et al. Geometric imaging of borophene polymorphs with functionalized probes. Nat. Commun. 10, 1642 (2019).
[29]. Hapala, P. et al. Mechanism of high-resolution STM/AFM imaging with functionalized tips. Phys. Rev. B 90, 085421 (2014).
[30]. Liu, X., Wang, L., Yakobson, B. I. & Hersam, M. C. Nanoscale probing of image-potential states and electron transfer doping in borophene polymorphs. Nano. Lett. 21, 1169-1174 (2021).
[31]. Karmodak, N. & Jemmis, E. D. Metal templates and boron sources controlling borophene structures: An ab initio study. J. Phys. Chem. C 122, 2268-2274 (2018).
[32]. Zheng, B. et al. Highly effective work function reduction of α-borophene via caesium decoration: A first-principles investigation. Adv. Theory Simul. 3, 1900249 (2020).
[33]. Lu, C.-I., et al., Graphite edge controlled registration of monolayer MoS₂ crystal orientation Appl. Phys. Lett. 106, 181904 (2015).
[34]. Perdew, J. P., Burke, K., Ernzerhof, M. Generalized gradient approximation made simple. Phys. Rev. Lett. 77, 3865-3868 (1996).
[35]. Blöchl, P. E. Projector augmented-wave method. Phys. Rev. B 50, 17953-17979 (1994).
[36]. Kresse, G., Furthmüller, J. Efficient iterative schemes for ab initio total-energy calculations using a plane-wave basis set. Phys. Rev. B 54, 11169-11186 (1996).
[37]. Grimme, S. Semiempirical GGA-type density functional constructed with a long-range dispersion correction. J. Comput. Chem. 27, 1787-1799 (2006).
[38]. Krejc̆i, O., Hapala, P., Ondrác̆ek, M., Jelínek, P. Principles and simulations of high-resolution STM imaging with a flexible tip apex. Phys. Rev. B 95, 045407 (2017).
[39]. Shearer, C. J., Slattery, A. D., Stapleton, A. J., Shapter, J. G., Gibson, C. T. Accurate thickness measurement of graphene. Nanotechnology 27, 125704 (2016).
[40]. X. Zheng, et al., 2D Mater. 7, 011001 (2020).
[41]. M. Liao, et al., Nat. Phys. 14, 344-348(2018).
[42]. J. E. Yaokawa, et al., Nat. Commun. 7, 10657 (2016).
[43]. P. Vogt, et al., Appl. Phys. Lett. 104, 021602 (2014).
[44]. Padilha, et al., J. Phys. Chem. C 119, 3818-3825 (2015).
[45]. F. Ma, et al. Nano Lett. 16, 3022-3028 (2016).
[46]. Z. Zhang, et al., Nano Lett. 16, 6622-6627 (2016).

What is claimed is:

1. A method of synthesizing multi-atomic layer borophene, comprising:
depositing boron on a substrate with atomically flat terraces at a temperature in an ultrahigh vacuum (UHV) chamber to grow multi-atomic layer borophene beyond a full coverage of single-atomic layer (SL) borophene.

2. The method of claim 1, wherein the temperature is at about 200-700° C. during boron deposition.

3. The method of claim 2, wherein the temperature is around 450° C.

4. The method of claim 1, wherein the atomically flat terraces are micrometer-sized atomically flat terraces having widths exceeding about 1 μm.

5. The method of claim 1, wherein the multi-atomic layer borophene comprises bilayer (BL) borophene.

6. The method of claim 5, wherein the BL borophene is BL-α borophene comprising two covalently bonded α-phase borophene monolayers.

7. The method of claim 6, wherein the BL-α borophene is in form of a highly faceted island with a six-fold symmetric Moiré superlattice surrounded by full-coverage intermixed SL v_{1/5} and v_{1/6} borophene.

8. The method of claim 6, wherein the BL-α borophene nucleates and emerges at intersections of multiple SL borophene domains.

9. The method of claim 6, wherein the BL-α borophene has a work function exceeding that of SL borophene.

10. The method of claim 6, wherein the BL-α borophene is metallic.

11. The method of claim 1, wherein the UHV chamber is in a vacuum level better than 10⁻⁹ Torr during the borophene growth.

12. The method of claim 1, wherein the substrate comprises a substrate having a metal film formed of Ag, Au, Cu, Al, or Ir.

13. The method of claim 12, wherein the substrate is a single-crystal Ag(111) substrate.

14. The method of claim 13, wherein the single-crystal Ag(111) substrate is obtained by repeated ion sputtering followed by thermal annealing at above 500° C., thereby forming atomically flat Ag(111) terraces with typical width exceeding about 1 μm.

15. The method of claim 1, wherein said depositing the boron is performed by electron-beam evaporation of a solid boron rod, or high temperature effusion of the solid boron rod in a high temperature effusion cell.

16. The method of claim 15, wherein the solid boron rod has a purity of about 99.999-99.99999% boron.

17. The method of claim 15, wherein the flux of boron during deposition is maintained at above 10 nA using a filament current above 1 A and accelerating voltage above 1 kV.

18. The method of claim 1, wherein the deposition time is about 10-100 min to achieve more than the full monolayer coverage of boron.

19. Multi-atomic layer borophene, being synthesized according to the method of claim 1.

20. The multi-atomic layer borophene of claim 19, wherein the multi-atomic layer borophene comprises bilayer (BL) borophene.

21. The multi-atomic layer borophene of claim 20, wherein the BL borophene is BL-α borophene comprising two covalently bonded α-phase borophene monolayers.

22. The multi-atomic layer borophene of claim 21, wherein the BL-α borophene is in form of a highly faceted island with a six-fold symmetric Moiré superlattice surrounded by full-coverage intermixed SL v_{1/5} and v_{1/6} borophene.

23. The multi-atomic layer borophene of claim 21, wherein the BL-α borophene nucleates and emerges at intersections of multiple SL borophene domains.

24. The multi-atomic layer borophene of claim 21, wherein the BL-α borophene has a work function exceeding that of SL borophene.

25. The multi-atomic layer borophene of claim 21, wherein the BL-α borophene is metallic.

26. A composition, comprising:
multi-atomic layer borophene containing multiple monolayer borophenes grown one on top of another and covalently bonded to each other.

27. The composition of claim 26, wherein the multi-atomic layer borophene comprises bilayer (BL) borophene.

28. The composition of claim 27, wherein the BL borophene is BL-α borophene comprising two covalently bonded α-phase borophene monolayers.

29. The composition of claim 28, wherein the BL-α borophene is in form of a highly faceted island with a six-fold symmetric Moiré superlattice surrounded by full-coverage intermixed SL v_{1/5} and v_{1/6} borophene.

30. The composition of claim 28, wherein the BL-α borophene nucleates and emerges at intersections of multiple SL borophene domains.

31. The composition of claim 28, wherein the BL-α borophene has a work function exceeding that of SL borophene.

32. The composition of claim 26, being metallic.
